(19) United States
(12) Patent Application Publication
(10) Pub. No.: US 2020/0295397 A1
(43) Pub. Date: Sep. 17, 2020

(54) LITHIUM SECONDARY BATTERY

(71) Applicant: TDK CORPORATION, TOKYO (JP)

(72) Inventors: Satoru HIRAKAWA, TOKYO (JP); Yasuhiro TAKAGI, TOKYO (JP); Tohru INOUE, TOKYO (JP)

(73) Assignee: TDK CORPORATION, TOKYO (JP)

(21) Appl. No.: 16/810,216

(22) Filed: Mar. 5, 2020

(30) Foreign Application Priority Data
Mar. 15, 2019 (JP) 2019-047943

(51) Int. Cl. H01M 10/0525; H01M 2/16; H01M 4/134

(52) U.S. Cl. CPC H01M 10/0525; H01M 2004/028; H01M 4/134; H01M 2/1673

(57) ABSTRACT

Disclosed herein is a lithium secondary battery that includes an electrode assembly having a weight energy density of 250 Wh/Kg or more, and a heat exhaust layer provided on a surface of the electrode assembly. The electrode assembly has a structure in which a positive electrode and a negative electrode are alternately stacked through a separator. The positive electrode includes a positive electrode current collector and a positive electrode active material layer formed on a surface of the positive electrode current collector. The negative electrode including a negative electrode current collector and a negative electrode active material layer formed on a surface of the negative electrode current collector.

### BACKGROUND OF THE INVENTION

### Field of the Invention

The present invention relates to a lithium secondary battery and, more particularly, to a lithium secondary battery having a high weight energy density by use of silicon (Si), tin (Sn), lithium (Li), or oxide thereof as a negative electrode active material.

### Description of Related Art

A lithium secondary battery has recently been put into practical use as a secondary battery exhibiting a high output and a high weight energy density. The lithium secondary battery is more excellent in weight energy density, cycle characteristics, output-input characteristics, storage characteristics than conventional secondary batteries, so that it is becoming widely prevalent in the fields of mobile devices, on-vehicle batteries, household heavy appliances, and the like.

As described in Japanese Patent No. 5,319,613, in a general lithium secondary battery, graphite is used as a negative electrode active material. The theoretical capacity of graphite is 372 mAh/g. In recent years, in order to achieve a higher weight energy density than the general lithium secondary battery using graphite as a negative electrode active material, a lithium secondary battery of a type using, as a negative electrode active material, inorganic particles composed of silicon (Si), or silicon oxide (SiOx) having a significantly higher theoretical capacity than graphite and a lithium secondary battery of a type using metal as a negative electrode are currently under development (see JP 2013-191578A).

Lithium secondary batteries have a structure in which positive and negative electrodes are alternately stacked through a separator, so that heat is likely to be retained in the center of an electrode assembly, which is likely to accelerate deterioration. Thus, in order to reduce the deterioration due to heat, attempts have been made to reduce electrode resistance by increasing the component ratio of a conductive auxiliary agent or reducing electrode thickness so as to suppress heat generation.

However, recently, a further increase in weight energy density is demanded, and in order to achieve this, a reduction in the component ratio of the conductive auxiliary agent or an increase in the electrode thickness is required. That is, heat generation suppression and increase in weight energy density are in a trade-off relationship, and it is not easy to satisfy both at the same time.

In particular, a lithium secondary battery having a weight energy density of 250 Wh/Kg or more by use of silicon (Si), tin (Sn), lithium (Li), or oxide thereof as a negative electrode active material is larger in expansion/contraction amount associated with charge/discharge than a general lithium secondary battery using graphite as a negative electrode active material and thus generates a larger amount of heat. Such heat generation is derived from a material, so that it is difficult to sufficiently suppress the heat generation with the existing methods such as an increase in the component ratio of the conductive auxiliary agent or a reduction in the electrode thickness.

### SUMMARY

It is therefore an object of the present invention to suppress degradation of an electrode assembly due to heat in a lithium secondary battery having a significantly higher weight energy density than a general lithium secondary battery.

A lithium secondary battery according to the present invention includes an electrode assembly having a weight energy density of 250 Wh/Kg or more, and a heat exhaust layer provided on a surface of the electrode assembly. The electrode assembly has a structure in which a positive electrode and a negative electrode are alternately stacked through a separator. The positive electrode includes a positive electrode current collector and a positive electrode active material layer formed on a surface of the positive electrode current collector. The negative electrode including a negative electrode current collector and a negative electrode active material layer formed on a surface of the negative electrode current collector.

The electrode assembly constituting a lithium secondary battery having a weight energy density of 250 Wh/Kg or higher generates a significantly larger amount of heat in the center thereof than that constituting a general lithium secondary battery does. However, in the lithium secondary battery according to the present invention, the heat exhaust layer is provided on the surface of the electrode assembly, so that thermal gradient between the center of the electrode assembly and the heat exhaust layer increases and, thus, heat retained in the center of the electrode assembly can be efficiently dissipated outside.

The lithium secondary battery according to the present invention may further include an outer casing that houses therein the electrode assembly and the heat exhaust layer, and the heat exhaust layer may be positioned between the electrode assembly and the outer casing. With this configuration, heat generated in the electrode assembly can be efficiently dissipated to the outer casing through the heat exhaust layer.

In the present invention, the heat exhaust layer may be electrically connected to the positive electrode or negative electrode. With this configuration, heat conduction occurs through an electric path between the heat exhaust layer and the positive electrode or negative electrode, whereby a heat exhausting property can be further enhanced.

In the present invention, the electrode assembly may have a weight energy density of 280 Wh/Kg or more. In this case, the heat generation amount of the electrode assembly associated with charging/discharging becomes larger, thus making an effect brought about by the heat exhaust layer more conspicuous.

In the present invention, the negative electrode active material layer may contain, as a negative electrode active material, at least one of silicon (Si), tin (Sn), lithium (Li) and oxide thereof. This makes it possible to achieve a weight energy density of 250 Wh/Kg or more.

As described above, according to the present invention, degradation of the electrode assembly due to heat can be suppressed in a lithium secondary battery having a significantly higher weight energy density than a general lithium secondary battery.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a schematic cross-sectional view of a lithium secondary battery according to a first embodiment of the present invention;

FIG. 2A is a schematic cross-sectional view illustrating the structure of the positive electrode;

FIG. 2B is a schematic cross-sectional view illustrating the structure of the negative electrode;

FIG. 3 is a schematic cross-sectional view of a lithium secondary battery according to a second embodiment of the present invention;

FIG. 4 is a schematic cross-sectional view of a lithium secondary battery according to a third embodiment of the present invention;

FIG. 5 is a schematic cross-sectional view of a lithium secondary battery according to a fourth embodiment of the present invention;

FIG. 6 is a schematic cross-sectional view of a lithium secondary battery according to a fifth embodiment of the present invention;

FIG. 7A is a schematic cross-sectional view illustrating the structure of the positive electrode shown in FIG. 6; and

FIG. 7B is a schematic cross-sectional view illustrating the structure of the negative electrode shown in FIG. 6.

### DETAILED DESCRIPTION OF THE EMBODIMENTS

Preferred embodiments of the present invention will be explained below in detail with reference to the accompanying drawings.

### First Embodiment

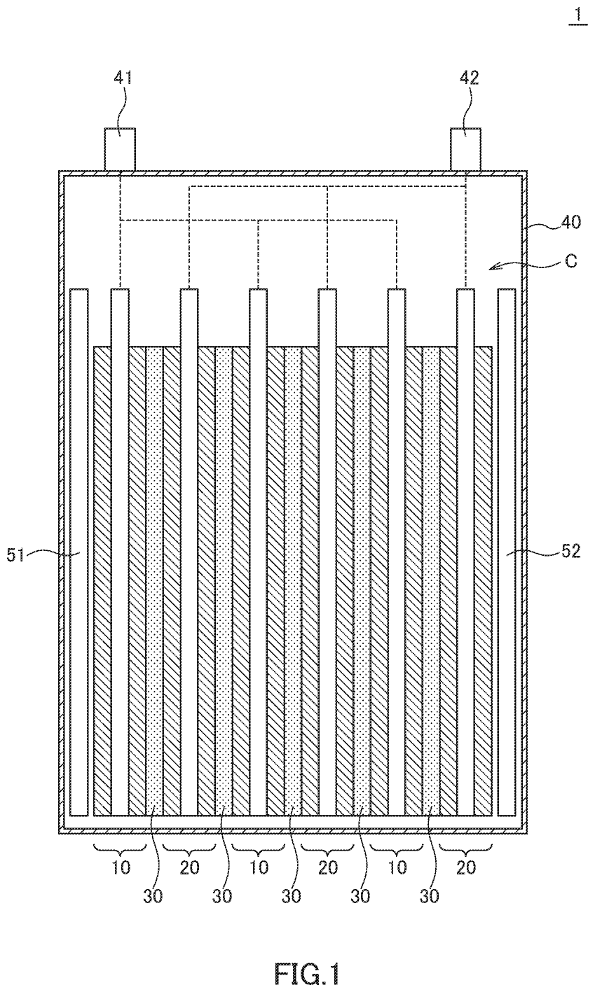

FIG. 1 is a schematic cross-sectional view of a lithium secondary battery 1 according to the first embodiment of the present invention.

As illustrated in FIG. 1, the lithium secondary battery 1 according to the first embodiment includes an electrode assembly C, an outer casing 40 that houses therein the electrode assembly C in a sealed state, and a pair of terminal electrodes 41 and 42 led out from the outer casing 40. Although not illustrated, a non-aqueous electrolyte solution is encapsulated in the outer casing 40 together with the electrode assembly C.

The electrode assembly C has a structure in which positive and negative electrodes 10 and 20 are alternately stacked through a separator 30. Although three positive electrodes 10 and three negative electrodes 20 are stacked in the example of FIG. 1, the numbers of the positive and negative electrodes 10 and 20 are not limited thereto. Further, the number of the positive electrodes 10 and the number of negative electrodes 20 need not be the same.

The outermost positive electrode 10 or outermost negative electrode 20 constituting the electrode assembly

C is covered with first and second heat exhaust layers 51 and 52. In the example of FIG. 1, the outermost layer on one side of the electrode assembly C is constituted by the positive electrode 10, and the outermost layer on the other side of the electrode assembly C is constituted by the negative electrode 20. The first heat exhaust layer 51 is provided between the outermost positive electrode 10 and the outer casing 40, and the second heat exhaust layer 52 is provided between the outermost negative electrode 20 and the outer casing 40.

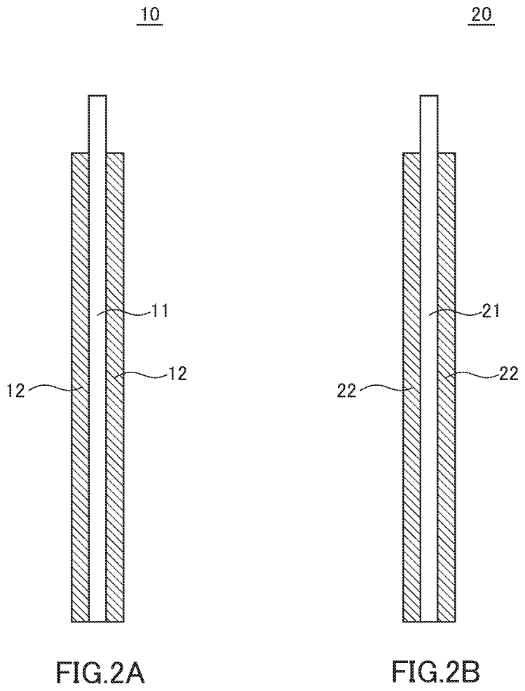

FIG. 2A is a schematic cross-sectional view illustrating the structure of the positive electrode 10, and FIG. 2B is a schematic cross-sectional view illustrating the structure of the negative electrode 20.

As illustrated in FIG. 2A, the positive electrode 10 includes a plate-like (film-like) positive electrode current collector 11 and positive electrode active material layers 12 formed on both surfaces of the positive electrode current collector 11.

The positive electrode current collector 11 may be made of a conductive plate material. For example, a metal foil or a metal thin plate made of aluminum, copper, or nickel may be used. The positive electrode current collectors 11 are connected in common to the terminal electrode 41 illustrated in FIG. 1.

The positive electrode active material layer 12 includes a positive electrode active material, a positive electrode conductive auxiliary agent, and a positive electrode binder. The component ratio of the positive electrode active material in the positive electrode active material layer 12 is preferably 80% or more and 90% or less in a mass ratio. Further, the component ratio of the positive electrode conductive auxiliary agent in the positive electrode active material layer 12 is preferably 0.5% or more and 10% or less in a mass ratio, and the component ratio of the positive electrode binder in the positive electrode active material layer 12 is preferably 0.5% or more and 10% or less in a mass ratio.

The positive electrode active material may be an electrode active material capable of reversibly progressing lithium ion absorption and release, lithium ion desorption and intercalation, or doping and dedoping between lithium ion and a counter anion (e.g., PF₆⁻) of lithium ion.

Examples of the positive electrode active material include lithium cobalt oxide (LiCoO₂), lithium nickel oxide (LiNiO₂), lithium-manganese spinel (LiMn₂O₄), and lithium nickel composite oxide represented by a general formula: LiₐNi_{b}Mn_{c}Co_{d}MₓO₂ (where a, b, c, d, and x satisfy 0.9≤a≤1.2, 0<b<1, 0<c≤0.5, 0<d0.5, 0≤x≤0.3, b+c+d=1, and M is at least one element selected from a group consisting of Ti, Zr, Nb, W, P, Al, Mg, V, Ca, Sr, and Cr), lithium vanadium compound (LiV₂O₅), and compound metal oxides such as olivine-type LiMPO₄ (where M is at least one element selected from a group consisting of Co, Ni, Mn, Fe, Mg, Nb, Ti, Al, and Zr, or VO), lithium titanate (Li₄Ti₅O₁₂), and LiNiₓCo_{y}Al_{z}O₂ (0.9<x+y+z<1.1).

Concrete examples of the positive electrode active material include lithium nickel-cobalt-aluminate (NCA), lithium cobalt oxide (LCO), and lithium nickel-cobalt-manganese oxide (NCM).

Examples of the positive electrode conductive auxiliary agent contained in the positive electrode active material layer 12 include carbon powder such as carbon blacks, fine metal powder such as carbon nanotube, carbon materials, copper, nickel, stainless steel, and iron, a mixture of carbon materials and fine metal powder, and conductive oxide such as ITO. When sufficient conductivity can be achieved with only the positive electrode active material, the positive electrode active material layer 12 need not contain the positive electrode conductive auxiliary agent.

The positive electrode binder contained in the positive electrode active material layer 12 plays a role of binding the positive electrode active materials and binding the positive electrode active material and the positive electrode current collector 11. The positive electrode binder may be any material capable of achieving the above bonding, and examples thereof include fluororesins such as polyvinylidene fluoride (PVDF), polyethersulfone (PESU), polytetrafluoroethylene (PTFE), tetrafluoroethylene-hexafluoropropylene copolymer (FEP), tetrafluoroethylene-perfluoroalkylvinylether copolymer (PFA), ethylene-tetrafluoroethylene copolymer (ETFE), polychlorotrifluoroethylene (PCTFE), ethylene-chlorotrifluoroethylene copolymer (PCTFE), and polyvinylfluoride (PVF).

In addition to those described above, vinylidene fluoride fluorine rubber may be used as the positive electrode binder, and concrete examples thereof include: vinylidene fluoride-hexafluoropropylene fluorine rubber (VDF-HFP fluorine rubber), vinylidene fluoride-hexafluoropropylene-tetrafluoroethylene fluorine rubber (VDF-HFPTFE fluorine rubber), vinylidene fluoride-pentafluoropropylene fluorine rubber (VDF-PFP fluorine rubber), vinylidene fluoride-pentafluoropropylene-tetrafluoroethylene fluorine rubber (VDF-PFP-TFE fluorine rubber), vinylidene fluoride-perfluoromethylvinylether-tetrafluoroethylene fluorine rubber (VDF-PFMVE-TFE fluorine rubber), and vinylidene fluoride-chlorotrifluoroethylene fluorine rubber (VDF-CTFE fluorine rubber).

The positive electrode binder may be formed of conductive polymer with electronic conductivity and conductive polymer with ionic conductivity. An example of the conductive polymer with electronic conductivity is polyacetylene. In this case, the positive electrode binder exhibits the function of a positive electrode conductive auxiliary agent and, therefore, a positive electrode conductive auxiliary agent need not be added. An example of the conductive polymer with ionic conductivity is obtained by combining alkali metal salt, which contains lithium salt or lithium mainly, with a polymer compound such as polyethylene oxide and polypropylene oxide.

As illustrated in FIG. 2B, the negative electrode 20 includes a plate-like (film-like) negative electrode current collector 21 and a negative electrode active material layer 22 formed on both surfaces of the negative electrode current collector 21.

The negative electrode current collector 21 may be made of a conductive plate material. For example, a metal foil or a metal thin plate made of aluminum, copper, or nickel may be used. The negative electrode current collectors 21 are connected in common to the terminal electrode 42 illustrated in FIG. 1. The negative electrode active material layer 22 includes a negative electrode active material, a negative electrode conductive auxiliary agent, and a negative electrode binder.

The negative electrode active material is composed of particles containing at least silicon (Si), tin (Sn), lithium (Li) or oxide thereof. However, inorganic particles or carbon material particles other than the above may be contained. Such a negative electrode active material is higher in capacity than graphite and can have a capacity per unit area of 1.2 mAh/cm² or more and a rated capacity of 3 Ah or more.

As the negative electrode conductive auxiliary agent, the same material as that for the positive electrode conductive auxiliary agent can be used. That is, carbon powder such as carbon blacks, fine metal powder such as carbon nanotube, carbon materials, copper, nickel, stainless steel, and iron, a mixture of carbon materials and fine metal powder, and conductive oxide such as ITO can be used.

As negative electrode binder, the same material as for the positive electrode binder used in the positive electrode active material layer 12 can be used. Other examples of the negative electrode binder include, e.g., cellulose, styrene butadiene rubber, ethylene propylene rubber, polyimide resin, polyamide imide resin, and acrylic resin.

The thus configured positive and negative electrodes 10 and 20 are alternately stacked through the separator 30. During charging, lithium ions move from the positive electrode 10 through the separator 30, whereby lithium is absorbed into the negative electrode active material, or lithium metal is deposited on the surface of the negative electrode current collector 21. When discharge is progressed, lithium is released from the particles of the negative electrode active material, or lithium metal deposited on the negative electrode current collector 21 is dissolved, whereby lithium ions move to the positive electrode 10 through the separator 30.

The separator 30 is formed of a porous structure with an electrically insulating property. Examples of the separator 30 include a single or multilayer film made of polyethylene, polypropylene, or polyolefin, extended films of mixtures of the resins mentioned above, and fibrous nonwoven fabrics made of at least one kind of constituent material selected from a group consisting of cellulose, polyester, and polypropylene. The separator 30 may be formed by laminating a heat-resistant insulating layer on a porous body.

The outer casing 40 houses therein the electrode assembly C and non-aqueous electrolyte solution in a sealed manner. The type of the outer casing 40 is not particularly limited as long as it can prevent the non-aqueous electrolyte solution from leaking outside and prevent moisture and the like from entering the inside of the lithium secondary battery 1. For example, a metal laminate film obtained by coating a metal foil from both sides with two polymer films can be used as the outer casing 40. In this case, an aluminum foil can be used as the metal foil, and a polypropylene film can be used as the polymer film. As the material for the outer polymer film, a polymer having a high melting point, such as polyethylene terephthalate (PET) or polyamide is preferably used, and as the material for the inner polymer film, polyethylene (PE) or polypropylene (PP) is preferably used.

The non-aqueous electrolyte solution may be an electrolyte (aqueous electrolyte solution or electrolyte solution using an organic solvent) containing lithium salt. However, the aqueous electrolytic solution has an electrochemically low decomposition voltage, which limits the tolerable voltage during charging, so that the electrolyte solution (non-aqueous electrolyte solution) using an organic solvent is preferably used. As the electrolyte, a solution obtained by dissolving lithium salt in non-aqueous solvent (organic solvent) is suitably used. The lithium salt is not particularly limited, and any lithium salt that can be used as an electrolyte for a lithium ion secondary battery may be used. Examples of the lithium salt include an inorganic acid anionic salt such as LiPF₆, LiBF₄, LiClO₄, LiFSI, or LiBOB, and an organic acid anionic salt such as LiCF₃SO₃, LiTFSI, or LiBETI.

Examples of the organic solvent include an aprotic high-dielectric-constant solvent such as ethylene carbonate, propylene carbonate, or fluoroethylene carbonate and an aprotic low-viscosity solvent such as acetates, such as dimethyl carbonate or ethylmethyl carbonate, or propionates. The aprotic high-dielectric-constant solvent and aprotic low-viscosity solvent are desirably used together at an adequate mixing ratio.

The non-aqueous electrolyte solution may contain an ionic liquid. The ionic liquid is a salt obtained by combinations of cations and anions and is liquid even at a temperature of less than 100° C. The ionic liquid is a liquid composed only of ions, so that it is characterized by strong electrostatic interaction, non-volatility, and non-flammability. A lithium secondary battery using the ionic liquid as the electrolyte solution is excellent in safety. Various types of ionic liquids are obtained by combinations of the cations and the anions. Examples of the ionic liquid include a nitrogen-based ionic liquid such as an imidazolium salt, a pyrrolidinium salt, a piperidinium salt, a pyridinium salt, or an ammonium salt, a phosphorus-based ionic liquid such as a phosphonium salt, and a sulfur-based ionic liquid such as a sulfonium salt. The nitrogen-based ionic liquid can be classified into ring ammonia salts and chain ammonia salts. Examples of the lithium salt include an inorganic acid anionic salt such as LiPF₆, LiBF₄, or LiBOB and an organic acid anionic salt such as LiTFSA (LiN (CF₃SO₂)₂), LiFSA (LiN (FSO₂)₂), LiCF₃SO₃, (CF₃SO₂)₂NLi, or (FSO₂)₂NLi.

The concentration of the lithium salt contained in the electrolyte solution is preferably 0.5 M to 2.0 M in terms of electric conductivity. The conductivity of the electrolyte at a temperature of 25° C. is preferably 0.01 S/m or more and is controlled depending on the type of an electrolyte salt or concentration of the electrolyte salt.

The lithium secondary battery 1 according to the present embodiment uses silicon (Si), tin (Sn), lithium (Li), or oxide thereof as the negative electrode active material, so that unlike a general lithium secondary battery using graphite as the negative electrode active material, it can achieve a weight energy density of 250 Wh/Kg or more. Further, it is possible to achieve a weight energy density of 280 Wh/Kg or more by reducing the component ratio of the conductive auxiliary agent or increasing the electrode thickness.

The electrode assembly C having a weight energy density of 250 Wh/Kg or more generates a significantly larger amount of heat than a general lithium secondary battery using graphite as the negative electrode active material. Considering this, in the lithium secondary battery 1 according to the present embodiment, the heat exhaust layers 51 and 52 are disposed between the electrode assembly C and the outer casing 40.

The heat exhaust layers 51 and 52 may be made of a metal foil or a metal thin plate made of aluminum, copper, or nickel, like the positive and negative electrode current collectors 11 and 12. However, in order to ensure high heat conductivity, the material like the positive electrode active material layer 12 or negative electrode active material layer 22 is preferably not formed on the surfaces of the heat exhaust layers 51 and 52. That is, the heat exhaust layers 51 and 52 preferably do not have the same structure as the positive electrode 10 or negative electrode 20 and, even if the same metal foil or metal thin plate as for the positive and negative electrode current collectors 11 and 12 is used, the positive electrode active material layer 12 or negative electrode active material layer 22 is preferably not formed on the surfaces of the heat exhaust layers 51 and 52.

The material for the heat exhaust layers 51 and 52 may be the same as or different from that for the positive electrode current collector 11 or negative electrode current collector 21. The planar size of the heat exhaust layers 51 and 52 may also be the same as or different from that of the positive electrode current collector 11 or negative electrode current collector 21. Further, the thickness of the heat exhaust layers 51 and 52 may also be the same as or different from that of the positive electrode current collector 11 or negative electrode current collector 21. In particular, when the thickness of the heat exhaust layers 51 and 52 is made larger than that of the positive electrode current collector 11 or negative electrode current collector 21, heat exhaust efficiency can be further enhanced.

As described above, in the lithium secondary battery 1 according to the present embodiment, the heat exhaust layer is provided on the surface of the electrode assembly C, so that thermal gradient between the center of the electrode assembly C and the heat exhaust layers 51 and 52 increases. As a result, heat retained in the center of the electrode assembly C is efficiently dissipated outside, making it possible to suppress degradation of the electrode assembly C due to heat.

### Second Embodiment

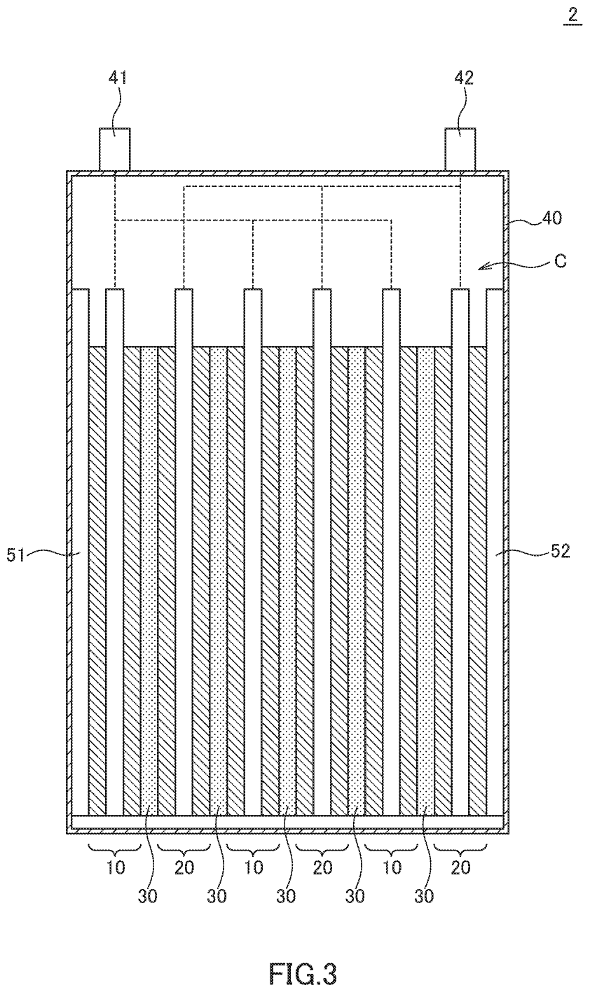

FIG. 3 is a schematic cross-sectional view of a lithium secondary battery 2 according to the second embodiment of the present invention.

As illustrated in FIG. 3, the lithium secondary battery 2 according to the second embodiment differs from the lithium secondary battery 1 according to the first embodiment in that the heat exhaust layers 51 and 52 contact the electrode assembly C and outer casing 40. Other configurations are the same as those of the lithium secondary battery 1 according to the first embodiment, so the same reference numerals are given to the same elements, and overlapping description will be omitted.

As exemplified in the present embodiment, in the present invention, the heat exhaust layer may contact the electrode assembly and the outer casing. With this configuration, heat generated inside the electrode assembly is efficiently dissipated to the outer casing through the heat exhaust layer.

### Third Embodiment

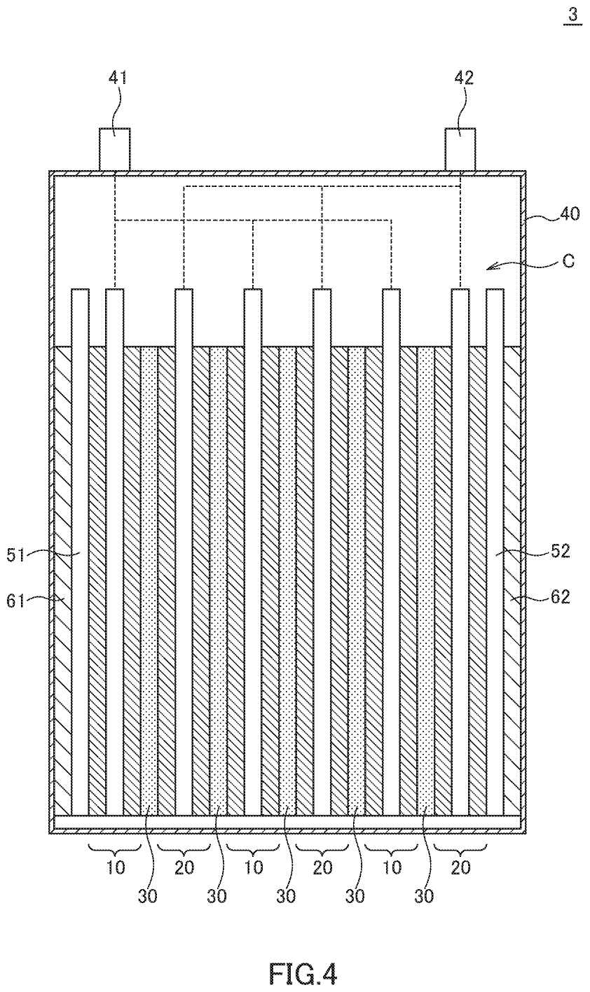

FIG. 4 is a schematic cross-sectional view of a lithium secondary battery 3 according to a third embodiment of the present invention.

As illustrated in FIG. 4, the lithium secondary battery 3 according to the third embodiment differs from the lithium secondary battery 2 according to the second embodiment in that adhesion layers 61 and 62 are provided between the outer casing 40 and the heat exhaust layers 51 and 52, respectively. Other configurations are the same as those of the lithium secondary battery 2 according to the second embodiment, so the same reference numerals are given to the same elements, and overlapping description will be omitted.

As exemplified in the present embodiment, in the present invention, another layer such as the adhesion layer may be interposed between the heat exhaust layer and the electrode assembly.

### Fourth Embodiment

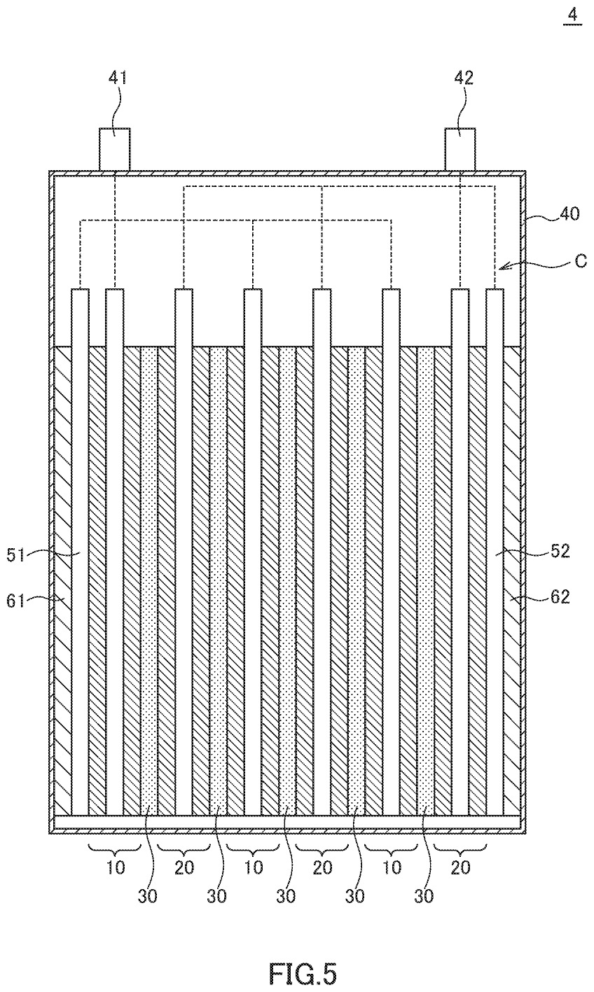

FIG. 5 is a schematic cross-sectional view of a lithium secondary battery 4 according to the fourth embodiment of the present invention.

As illustrated in FIG. 5, the lithium secondary battery 4 according to the fourth embodiment differs from the lithium secondary battery 3 according to the third embodiment in that the heat exhaust layers 51 and 52 are connected respectively to the terminal electrodes 41 and 42. Other configurations are the same as those of the lithium secondary battery 3 according to the third embodiment, so the same reference numerals are given to the same elements, and overlapping description will be omitted.

According to the present embodiment, heat conduction occurs through an electric path between the heat exhaust layer 51 and the positive electrode 10, and heat conduction occurs through an electric path between the heat exhaust layer 52 and the negative electrode 20. As a result, a heat exhausting property from the electrode assembly C to the heat exhaust layers 51 and 52 can be further enhanced.

### Fifth Embodiment

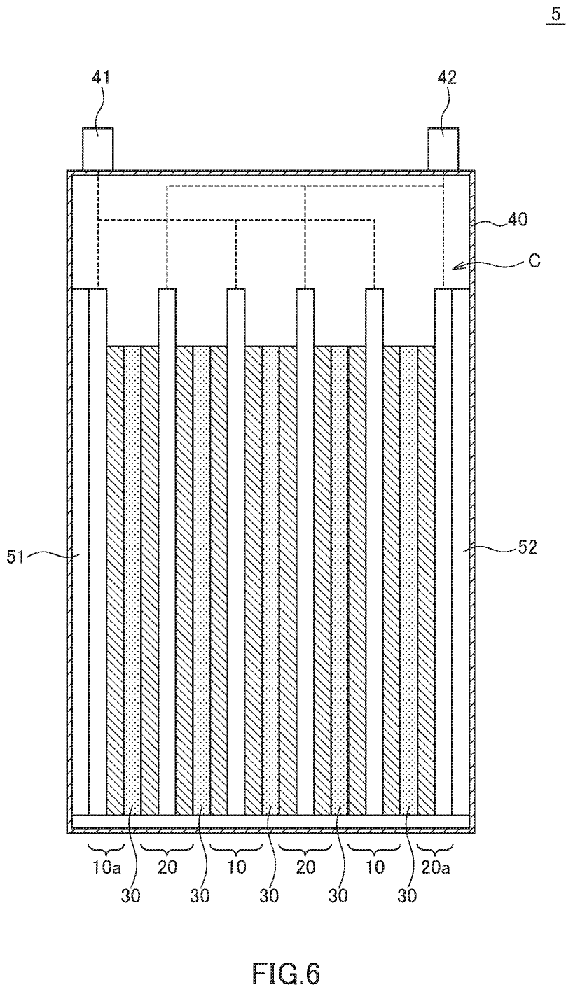

FIG. 6 is a schematic cross-sectional view of a lithium secondary battery 5 according to the fifth embodiment of the present invention.

As illustrated in FIG. 6, the lithium secondary battery 5 according to the fifth embodiment differs from the lithium secondary battery 2 according to the second embodiment in that the positive electrode current collector 11 constituting an outermost positive electrode 10a contacts the heat exhaust layer 51, and the negative electrode current collector 21 constituting an outermost negative electrode 20a contacts the heat exhaust layer 52. Other configurations are the same as those of the lithium secondary battery 2 according to the second embodiment, so the same reference numerals are given to the same elements, and overlapping description will be omitted.

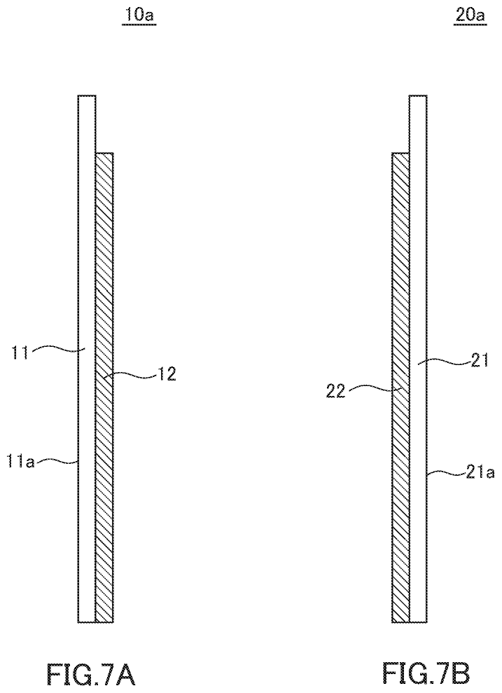

FIG. 7A is a schematic cross-sectional view illustrating the structure of the positive electrode 10a, and FIG. 7B is a schematic cross-sectional view illustrating the structure of the negative electrode 20a.

As illustrated in FIG. 7A, the outermost positive electrode 10a includes the positive electrode current collector 11 and the positive electrode active material layer 12 formed on one surface of the positive electrode current collector 11, and the other surface 11a of the positive electrode current collector 11 is exposed without being covered with the positive electrode active material layer 12. As illustrated in FIG. 7B, the outermost negative electrode 20a includes the negative electrode current collector 21 and the negative electrode active material layer 22 formed on one surface of the negative electrode current collector 21, and the other surface 21a of the negative electrode current collector 21 is exposed without being covered with the negative electrode active material layer 22.

In the present embodiment, the other surface 11a of the positive electrode current collector 11 contacts the heat exhaust layer 51, and the other surface 21a of the negative electrode current collector 21 contacts the heat exhaust layer 52. According to the present embodiment, the positive and negative electrode active material layers 12 and 22 that do not contribute to charging/discharging are removed, so that the weight energy density can be further increased, and a heat dissipation property through the heat exhaust layers 51 and 52 can be further enhanced.

In the first to fifth embodiments of the present invention, the following secondary effect can be recognized, in addition to enhancement of the heat dissipation property through the heat exhaust layers 51 and 52. That is, in an electrode assembly constituting a lithium secondary battery having a weight energy density of 250 Wh/Kg or more, the negative electrode active material layer 22 largely expands and contracts, and this expansion and contraction may lead to separation of particles of the active material or conductive auxiliary agent constituting the negative electrode active material layer 22. When the thus separated particles stay on the surface of the negative terminal, they may become a starting point of abnormal growth of metal lithium. In the first to fifth embodiments of the present invention, it is recognized that abnormal growth of metal lithium is significantly less than that in a lithium secondary battery not having the heat exhaust layers 51 and 52. It is considered that this effect is brought about by capture of the separated particles of the active material or conductive auxiliary agent between the heat exhaust layers 51, 52 and the separator 30, or between the heat exhaust layers 51, 52 and the outer casing 40.

It is apparent that the present invention is not limited to the above embodiments, but may be modified and changed without departing from the scope and spirit of the invention.

What is claimed is:

1. A lithium secondary battery comprising:
an electrode assembly having a weight energy density of 250 Wh/Kg or more; and
a heat exhaust layer provided on a surface of the electrode assembly,
wherein the electrode assembly has a structure in which a positive electrode and a negative electrode are alternately stacked through a separator,
wherein the positive electrode includes a positive electrode current collector and a positive electrode active material layer formed on a surface of the positive electrode current collector, and
wherein the negative electrode including a negative electrode current collector and a negative electrode active material layer formed on a surface of the negative electrode current collector.

2. The lithium secondary battery as claimed in claim 1, further comprising an outer casing that houses therein the electrode assembly and the heat exhaust layer,
wherein the heat exhaust layer is positioned between the electrode assembly and the outer casing.

3. The lithium secondary battery as claimed in claim 1, wherein the heat exhaust layer is electrically connected to the positive electrode or negative electrode.

4. The lithium secondary battery as claimed in claim 1, wherein the electrode assembly has a weight energy density of 280 Wh/Kg or more.

5. The lithium secondary battery as claimed in claim 1, wherein the negative electrode active material layer contains, as a negative electrode active material, at least one of silicon (Si), tin (Sn), lithium (Li) and oxide thereof.
